(19) United States
(12) Patent Application Publication
(10) Pub. No.: US 2025/0231469 A1
(43) Pub. Date: Jul. 17, 2025

(54) LIQUID CRYSTAL DEVICE, LIGHT MODULATION DEVICE, AND PROJECTOR

(71) Applicant: SEIKO EPSON CORPORATION, Tokyo (JP)

(72) Inventors: Yuki NAITO, MATSUMOTO-SHI (JP); Norikazu KADOTANI, AZUMINO-SHI (JP); Masanobu NAKANISHI, AZUMINO-SHI (JP); Masayuki WADA, NAGANO-SHI (JP)

(21) Appl. No.: 19/015,891

(22) Filed: Jan. 10, 2025

(30) Foreign Application Priority Data
Jan. 11, 2024 (JP) 2024-002427

(51) Int. Cl. G03B 21/16; G02F 1/1333; G03B 21/00

(52) U.S. Cl. CPC G03B 21/16; G02F 1/133308; G02F 1/133385; G03B 21/006; G02F 2202/28

(57) ABSTRACT

A liquid crystal device includes a liquid crystal panel including a pair of substrates which hold a liquid crystal layer, a panel holding member configured to hold the liquid crystal panel, and a first bonding layer configured to bond the liquid crystal panel to the panel holding member. The first bonding layer contains an adhesive and a plurality of first fillers added to the adhesive, which have a fibrous shape or a shape having a longitudinal axis. Thermal conductivity of the first fillers is higher than thermal conductivity of the adhesive.

The present application is based on, and claims priority from JP Application Serial Number 2024-002427, filed Jan. 11, 2024, the disclosure of which is hereby incorporated by reference herein in its entirety.

### BACKGROUND

### 1. Technical Field

The present disclosure relates to a liquid crystal device, a light modulation device, and a projector.

### 2. Related Art

In the related art, a liquid crystal projector using a liquid crystal device as a light modulation device is known. JP-A-2003-66408 discloses a liquid crystal device in which a silicone-based resin adhesive with high thermal conductivity is filled between a liquid crystal panel and a panel holding frame in order to efficiently dissipate heat generated by the liquid crystal panel.

However, in the above liquid crystal device, a gap between the panel holding frame and the liquid crystal panel is relatively large, and therefore, even when a silicone-based resin adhesive is used, a thickness of the adhesive results in a large thermal resistance. Therefore, it is difficult to efficiently transfer heat from the liquid crystal panel to the panel holding frame.

### SUMMARY

In order to solve the above problems, a liquid crystal device according to the present disclosure includes: a liquid crystal panel including a pair of substrates which hold a liquid crystal layer, a panel holding member configured to hold the liquid crystal panel, and a first bonding layer configured to bond the liquid crystal panel to the panel holding member. The first bonding layer contains an adhesive and first fillers added to the adhesive, which have a fibrous shape or a shape having a longitudinal axis. Thermal conductivity of the first fillers is higher than thermal conductivity of the adhesive.

A projector according to the present disclosure includes: a light source device; the liquid crystal device configured to modulate light emitted from the light source device; and a projection optical device configured to project the light modulated by the liquid crystal device.

A light modulation device according to the present disclosure includes: a light modulation element configured to modulate incident light as image light; a holding member configured to hold the light modulation element; and a bonding layer configured to bond the light modulation element to the holding member. The bonding layer contains an adhesive and a filler added to the adhesive, which has a fibrous shape or a shape having a longitudinal axis. Thermal conductivity of the filler is higher than thermal conductivity of the adhesive.

A projector according to another aspect of the present disclosure includes: a light source device; the light modulation device configured to modulate light emitted from the light source device; and a projection optical device configured to project the light modulated by the light modulation device.

### BRIEF DESCRIPTION OF THE DRAWINGS

FIG. 1 is a schematic configuration diagram of a projector according to a first embodiment.

FIG. 2 is an exploded perspective view showing a liquid crystal device as viewed from a light incident side.

FIG. 3 is a diagram showing a cross section of the liquid crystal device taken along a YZ plane.

FIG. 4 is an enlarged cross-sectional view showing a configuration of main parts of a first bonding layer.

FIG. 5 is a graph showing a relationship between a filler addition amount to the first bonding layer and a linear expansion coefficient.

FIG. 6 is an enlarged cross-sectional view showing a configuration of main parts of a first bonding layer according to a second embodiment.

FIG. 7 is an enlarged cross-sectional view showing the configurations of main parts of a first bonding layer according to a third embodiment.

FIG. 8 is an exploded perspective view of a liquid crystal device according to a fourth embodiment, as viewed from a light incident side.

FIG. 9 is an exploded perspective view of a liquid crystal device according to a fourth embodiment, as viewed from a light emission side.

### DESCRIPTION OF EMBODIMENTS

Embodiments of the present disclosure will be described below in detail with reference to the drawings. In the drawings used in the description below, a characteristic portion is enlarged for convenience in some cases for clarity of the characteristic thereof, and the dimension ratio and other factors of each component are therefore not always equal to actual values.

### First Embodiment

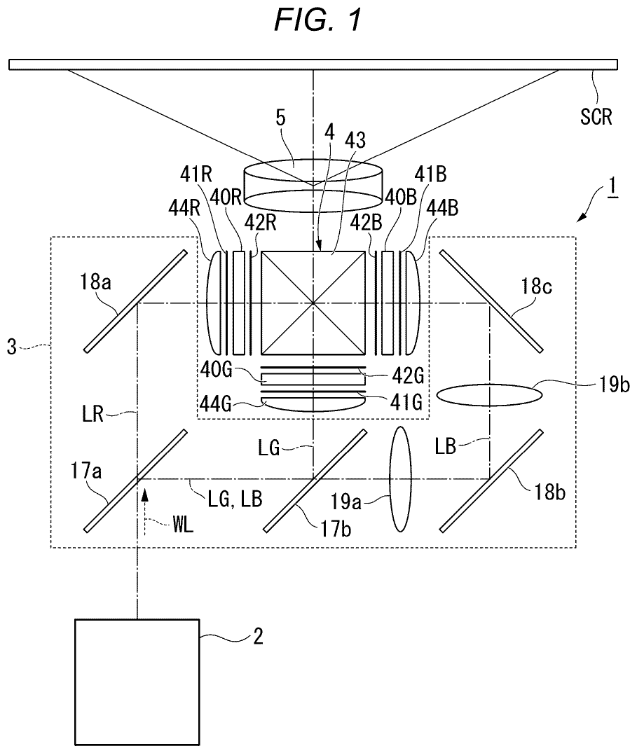

FIG. 1 is a schematic configuration diagram of a projector according to the present embodiment.

A projector 1 according to the embodiment is a projection-type image display device that displays videos on a screen SCR, as shown in FIG. 1. The projector 1 includes a light source device 2, a color separation optical system 3, an image forming device 4, and a projection optical device 5.

The light source device 2 outputs white illumination light WL toward the color separation optical system 3. A configuration of the light source device 2 may be, for example, a configuration including a solid-state light source that emits blue light as excitation light and a wavelength conversion element that converts at least a part of the blue light emitted from the solid-state light source into fluorescence including green light and red light. Another configuration of the light source device 2 may be a configuration including a light source lamp such as an ultra-high-pressure mercury lamp or a configuration including a light emitting element that emits blue light, green light, and red light individually.

The color separation optical system 3 separates the illumination light WL emitted from the light source device 2 into red light LR, green light LG, and blue light LB. The color separation optical system 3 includes a first dichroic mirror 17a, a second dichroic mirror 17b, a first total reflection mirror 18a, a second total reflection mirror 18b, a third total reflection mirror 18c, a first relay lens 19a, and a second relay lens 19b.

The first dichroic mirror 17a separates the illumination light WL from the light source device 2 into the red light LR and light including the green light LG and the blue light LB. The first dichroic mirror 17a transmits the red light LR and reflects the light containing the green light LG and the blue light LB. Meanwhile, the second dichroic mirror 17b reflects the green light LG and transmits the blue light LB. Accordingly, the second dichroic mirror 17b separates the light containing the green light LG and the blue light LB into the green light LG and the blue light LB.

The first total reflection mirror 18a is disposed in an optical path of the red light LR, and reflects the red light LR transmitted through the first dichroic mirror 17a toward the light modulation device 40R. Meanwhile, the second total reflection mirror 18b and the third total reflection mirror 18c are disposed in an optical path of the blue light LB, and guide the blue light LB transmitted through the second dichroic mirror 17b to the light modulation device 40B. The green light LG is reflected from the second dichroic mirror 17b toward the light modulation device 40G.

The first relay lens 19a and the second relay lens 19b are disposed in the optical path of the blue light LB on a light emission side of the second total reflection mirror 18b. The first relay lens 19a and the second relay lens 19b compensate for optical loss of the blue light LB resulting from the fact that an optical path length of the blue light LB is longer than optical path lengths of the red light LR and the green light LG.

The image forming device 4 modulates the incident red, green and blue light LR, LG and LB, respectively, and combines the modulated light LR, LG and LB to form image light. The image forming device 4 includes three light modulation devices 40R, 40G, 40B, three incident side polarizing plates 41R, 41G, 41B, three emission side polarizing plates 42R, 42G, 42B, one light combining system 43, and three field lenses 44R, 44G, 44B, which are disposed according to the incident color light.

The light modulation device 40R modulates the red light LR according to image information to form image light corresponding to the red light LR. The light modulation device 40G modulates the green light LG according to the image information to form image light corresponding to the green light LG. The light modulation device 40B modulates the blue light LB according to the image information to form image light corresponding to the blue light LB.

Specifically, the light modulation devices 40R, 40G, and 40B modulate the color light incident from the incident side polarizing plates 41R, 41G, and 41B according to an image signal input from a control device not shown, and emit the modulated image light of each color through the emission side polarizing plates 42R, 42G, and 42B.

In the embodiment, each of the light modulation devices 40R, 40G, and 40B is implemented by a transmissive liquid crystal device 6. The configuration of the liquid crystal device 6 will be described later.

The field lens 44R collimates the red light LR incident on the light modulation device 40R, the field lens 44G collimates the green light LG incident on the light modulation device 40G, and the field lens 44B collimates the blue light LB incident on the light modulation device 40B.

The image light of each color emitted from the light modulation devices 40R, 40G, and 40B is incident on the light combining system 43. The light combining system 43 combines the image light corresponding to the red light LR, the image light corresponding to the green light LG, and the image light corresponding to the blue light LB with one another and emits the combined image light toward the projection optical device 5. For example, a cross dichroic prism is used for the light combining system 43.

The projection optical device 5 includes a plurality of projection lenses. The projection optical device 5 enlarges the combined image light from the light combining system 43 and projects the enlarged image light toward the screen SCR. Accordingly, enlarged videos are displayed on the screen SCR.

Hereinafter, a configuration of the liquid crystal device 6 will be described. In the following description, three directions orthogonal to one another are referred to as a +X direction, a +Y direction, and a +Z direction. In the embodiment, the +Z direction is a traveling direction of light incident on the liquid crystal device 6. A left direction when the liquid crystal device 6 is viewed along the +Z direction so that the +Y direction coincides with an upward direction is defined as the +X direction. Although not shown, a direction opposite to the +X direction is referred to as a −X direction, a direction opposite to the +Y direction is referred to as a −Y direction, and a direction opposite to the +Z direction is referred to as a −Z direction. That is, the +Z direction with respect to the liquid crystal device 6 is the light emission side with respect to the liquid crystal device 6, and the −Z direction with respect to the liquid crystal device 6 is the light incident side with respect to the liquid crystal device 6.

In addition, an axis along the +X direction or the −X direction is defined as an X axis, an axis along the +Y direction or the −Y direction is defined as a Y axis, and an axis along the +Z direction or the −Z direction is defined as a Z axis.

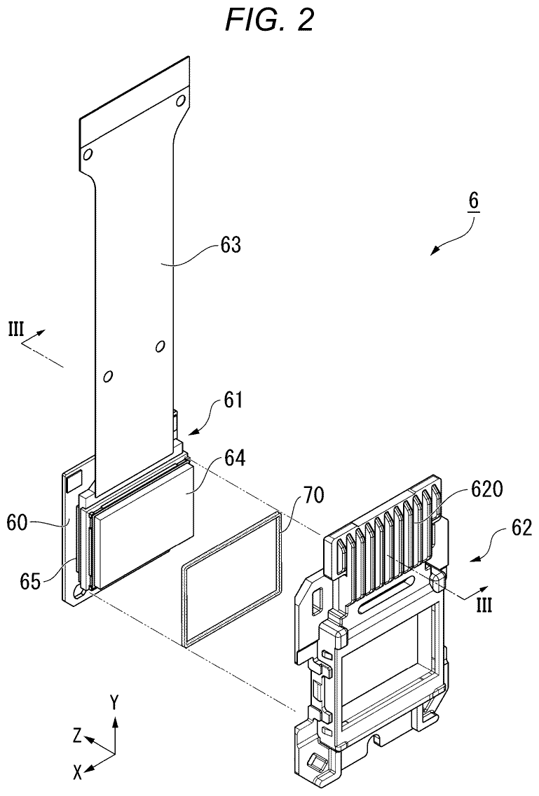

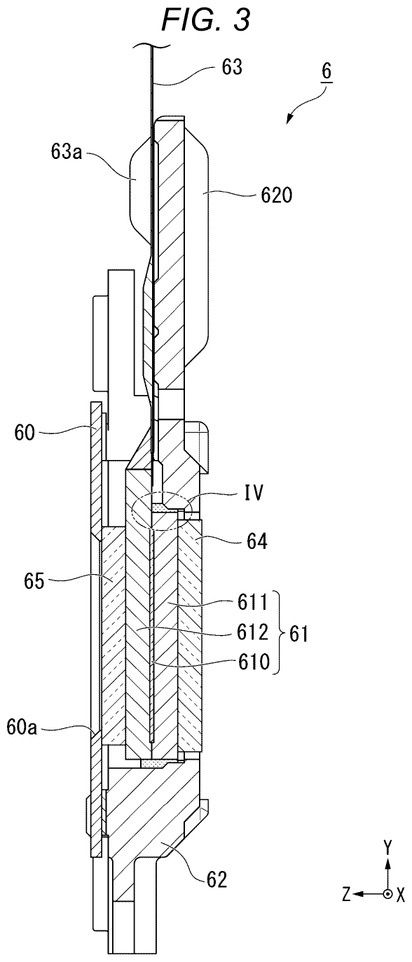

FIG. 2 is an exploded perspective view showing the liquid crystal device 6 as viewed from the light incident side. FIG. 3 is a diagram showing a cross section of the liquid crystal device 6 taken along a YZ plane.

As shown in FIGS. 2 and 3, the liquid crystal device 6 includes a liquid crystal panel 61, a panel holding member 62, a flexible printed circuit (FPC) 63, a first bonding layer 70 that bonds the liquid crystal panel 61 to the panel holding member 62, an incident side dustproof substrate 64 and an emission side dustproof substrate 65 that sandwich the liquid crystal panel 61 in a direction along the Z axis, and a back side plate 60.

The liquid crystal panel 61 includes a liquid crystal layer 610, and a counter substrate 611 and a pixel substrate 612 which are a pair of substrates sandwiching the liquid crystal layer 610 in the Z axis. The liquid crystal panel 61 has a pixel region containing a plurality of pixels.

The liquid crystal layer 610 is formed of liquid crystal molecules sealed between the counter substrate 611 and the pixel substrate 612. The counter substrate 611 is disposed on the light incident side with respect to the liquid crystal layer 610, and is made of, for example, quartz glass. A counter electrode is provided on a surface of the counter substrate 611 facing the liquid crystal layer 610.

The pixel substrate 612 is disposed on the light emission side with respect to the liquid crystal layer 610, and is made of, for example, quartz glass. A plurality of pixel electrodes are provided on a surface of the pixel substrate 612 facing the liquid crystal layer 610.

The counter substrate 611 and the pixel substrate 612 are connected to the FPC 63, and change an arrangement state of the liquid crystal molecules forming the liquid crystal layer 610 according to the image signal supplied from the FPC 63. Accordingly, the liquid crystal panel 61 modulates the incident light. That is, the liquid crystal device 6 modulates the light incident in the +Z direction by the liquid crystal layer 610 of the liquid crystal panel 61, and emits the modulated light modulated in the +Z direction.

The incident side dustproof substrate 64 is a transparent substrate provided on a light incident surface of the counter substrate 611. The incident side dustproof substrate 64 is provided to be able to transfer heat to the light incident surface of the counter substrate 611. The incident side dustproof substrate 64 prevents dust or the like from adhering to the light incident surface of the counter substrate 611 and a shadow of dust or the like from entering the image light.

The emission side dustproof substrate 65 is a transparent substrate provided on a light emission surface of the pixel substrate 612. The emission side dustproof substrate 65 is provided to be able to transfer heat to the light emission surface of the pixel substrate 612. The emission side dustproof substrate 65 prevents dust or the like from directly adhering to the light emission surface of the pixel substrate 612 and a shadow of dust or the like from entering the image light.

As shown in FIG. 3, the FPC 63 extends in the +Y direction from the counter substrate 611 and the pixel substrate 612, and is connected to a control device that controls an operation of the projector 1. The FPC 63 includes a drive chip 63a including a driver circuit for driving the liquid crystal panel 61, and supplies a drive signal corresponding to an image signal input from the control device to the pixel substrate 612.

The panel holding member 62 is a metal case that holds the liquid crystal panel 61 via the first bonding layer 70. The panel holding member 62 is disposed to surround an outer peripheral edge 61a of the liquid crystal panel 61 in a frame shape. The panel holding member 62 has a chip heat dissipation portion 620. The chip heat dissipation portion 620 is provided at a position corresponding to the drive chip 63a mounted on the FPC 63, and dissipates heat from the drive chip 63a.

The back side plate 60 is a sheet metal member that is disposed on the light emission side (back side) of the liquid crystal panel 61 and holds the liquid crystal panel 61 together with the panel holding member 62. The back side plate 60 has an opening 60a through which light emitted from the liquid crystal panel 61 passes.

The liquid crystal panel 61 generates heat by being driven. The heat from the liquid crystal panel 61 is transferred to the first bonding layer 70 and then to the panel holding member 62 via the first bonding layer 70.

The present inventor focuses on the fact that the heat from the liquid crystal panel 61 can be efficiently transferred to the panel holding member 62 by favorably forming a heat path from the liquid crystal panel 61 to the panel holding member 62 in the first bonding layer 70. Further, the configuration of the first bonding layer 70 of the liquid crystal device 6 according to the embodiment is found.

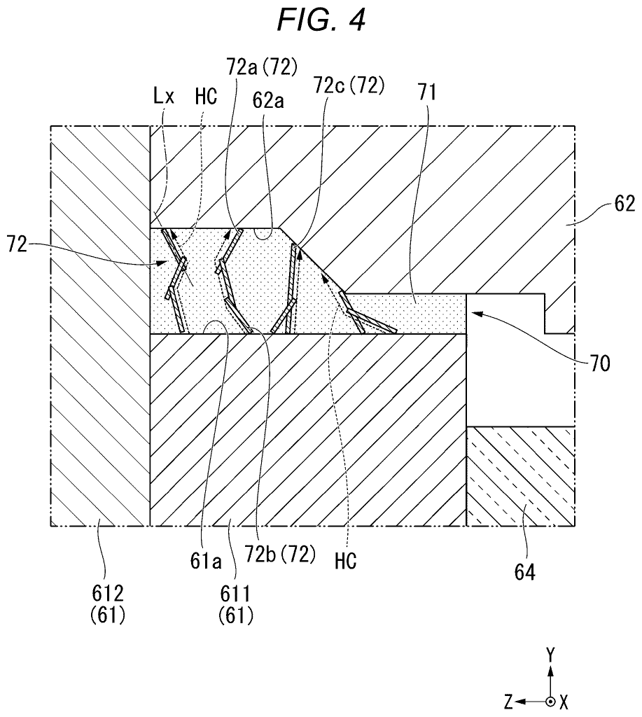

FIG. 4 is an enlarged cross-sectional view showing a configuration of main parts of the first bonding layer 70. FIG. 4 is an enlarged view of a region IV in FIG. 3.

As shown in FIG. 4, the first bonding layer 70 bonds the outer peripheral edge 61a of the liquid crystal panel 61 and an inner surface 62a of the panel holding member 62. Specifically, the first bonding layer 70 bonds a side surface 611a of the counter substrate 611 and a surface 612a of the pixel substrate 612 protruding from the counter substrate 611 to the inner surface 62a of the panel holding member 62.

The first bonding layer 70 contains an adhesive 71 and a plurality of first fillers 72 added to the adhesive 71.

Each of the plurality of first fillers 72 has a long axis shape. Here, the long axis shape is a shape extending in one direction, and may be a long spherical shape having an elliptical cross section, or may be a needle shape having pointed ends on both sides. Therefore, the first filler 72 having the long axis shape has a longitudinal axis Lx along a longitudinal direction.

The plurality of first fillers 72 are positioned such that the direction along the longitudinal axis Lx intersects a thickness direction of the first bonding layer 70. That is, the plurality of first fillers 72 are added to the adhesive 71 so as to be inclined rather than parallel to the side surface 611a of the counter substrate 611, the surface 612a or the side surface 612b of the pixel substrate 612, and the inner surface 62a of the panel holding member 62. Therefore, each first filler 72 is disposed in the adhesive 71 in a direction in which the longitudinal axis Lx is along the thickness direction of the first bonding layer 70.

As shown in FIG. 4, each of the plurality of first fillers 72 has a long axis shape, but the plurality of first fillers 72 are folded over in the adhesive 71 to form a fibrous shape as a whole. That is, the first bonding layer 70 according to the embodiment may include the adhesive 71 and the first filler 72 having a fibrous shape or a long axis shape having a longitudinal axis.

In the embodiment, the plurality of first fillers 72 include a filler 72a in contact with the liquid crystal panel 61 and a filler 72b in contact with the panel holding member 62. Specifically, the filler 72a is in contact with the side surface 611a of the counter substrate 611, the surface 612a or the side surface 612b of the pixel substrate 612, and the filler 72b is in contact with the inner surface 62a of the panel holding member 62.

In the embodiment, the plurality of first fillers 72 include a long filler 72c. Such a long filler 72c has one end in contact with the liquid crystal panel 61 and the other end in contact with the panel holding member 62.

It is preferable to use a material having excellent thermal conductivity as a material for the first fillers 72 having such a long axis shape or fibrous shape, such as titanium oxide, alumina (Al₂O₃), carbon, carbon nanotubes, boron nitride (BN), and BN nanotubes.

For example, a filler made of titanium oxide has an average particle diameter of several to several tens of um, a light reflectance of 90% to 98%, and thermal conductivity of 7.5 W/m·K to 10.5 W/m·K. The filler made of alumina (Al₂O₃) has an average particle diameter of several to several tens of μm, a light reflectance of 90%, and thermal conductivity of 20 W/m·K. The filler made of boron nitride (BN) has an average particle diameter of 1 μm or less, a light reflectance of 95%, and thermal conductivity of 200 W/m·K. The filler formed of BN nanotubes has an average particle diameter of several microns, a light reflectance of 95%, and thermal conductivity of about 3000 W/m·K. The filler made of carbon has an average particle diameter of 50 μm, a light reflectance of 5% or less, and thermal conductivity of 2000 W/m·K or less. The filler formed of carbon nanotubes has an average particle diameter of 1 μm or less, a light reflectance of 5% or less, and thermal conductivity of 3000 W/m·K to 6000 W/m·K or less.

In the embodiment, the adhesive 71 is made of a resin material having light transparency, for example, a silicone resin. The adhesive 71 made of a silicone resin has thermal conductivity of about 0.15 W/m·K. In the first bonding layer 70 according to the embodiment, the thermal conductivity of the first filler 72 is higher than the thermal conductivity of the adhesive 71.

Next, the operation of the liquid crystal device 6 according to the embodiment will be described. For ease of understanding, in FIG. 4, a heat path HC, which is a path of heat transferred from a liquid crystal panel 61 side to a panel holding member 62 side, is shown by a broken line.

In the liquid crystal device 6 according to the embodiment, first, the heat from the liquid crystal panel 61 is transferred to the filler closest to the liquid crystal panel 61 among the plurality of first fillers 72. In the embodiment, the heat from the liquid crystal panel 61 is transferred to the filler 72a in contact with the liquid crystal panel 61.

In the first bonding layer 70 according to the embodiment, since the longitudinal axis Lx of each of the first fillers 72 is along the thickness direction of the first bonding layer 70, any one of the plurality of first fillers 72 is disposed side by side in the thickness direction of the first bonding layer 70 in a state of being in contact with each other.

Therefore, the heat from the filler 72a is transferred to the first filler 72 in contact with the filler 72a, and finally transferred to the first filler 72 closest to the panel holding member 62. In the embodiment, the heat from the liquid crystal panel 61 is transferred from the filler 72 in contact with the inner surface 62a of the panel holding member 62 to the panel holding member 62. That is, the first bonding layer 70 forms the heat path HC for transferring the heat from the liquid crystal panel 61 to the panel holding member 62 by the plurality of first fillers 72 arranged in the thickness direction, so that the heat from the liquid crystal panel 61 can be efficiently dissipated from the panel holding member 62.

In addition, in the embodiment, since both ends of the long filler 72c are in contact with the liquid crystal panel 61 and the panel holding member 62, respectively, the long filler 72c alone can form the heat path HC in the first bonding layer 70.

It is preferable for the heat path HC from the liquid crystal panel 61 side to the panel holding member 62 side to be in a state in which the plurality of first fillers 72 are in contact with each other from the panel holding member 62 to the liquid crystal panel 61, but since the thermal conductivity is higher than that of a spherical-shaped filler in the related art, it is possible to enhance an effect of heat dissipation even if some of the fillers are not in contact with each other.

In the first bonding layer 70 according to the embodiment, since the plurality of first fillers 72 form a fibrous shape as a whole by being folded several times in the adhesive 71 as described above, a plurality of similar heat paths HC are formed inside the first bonding layer 70, as shown in FIG. 3.

Accordingly, the heat from the liquid crystal panel 61 is transferred to the panel holding member 62 via the first bonding layer 70, and is dissipated via the panel holding member 62.

To achieve the fibrous shape form, the plurality of first fillers are not limited to have a long axis shape, and a plurality of thread-shaped first fillers may be entangled with each other, and a plurality of curved first fillers entangled in thread form can form a heat path to obtain a similar effect.

Here, the heat from the liquid crystal panel 61 is transferred to surrounding members to thermally expand the surrounding members.

In the embodiment, the counter substrate 611 and the pixel substrate 612 constituting the liquid crystal panel 61 are made of quartz glass having a relatively low linear expansion coefficient. The linear expansion coefficient of the quartz glass is 0.5×E⁻⁶/° C.

On the other hand, the panel holding member 62 has a linear expansion coefficient higher than that of the quartz glass. In the embodiment, the panel holding member 62 is made of, for example, an aluminum alloy ADC12 or a magnesium alloy AZ91. The linear expansion coefficient of the ADC12 is 21×E⁻⁶/ C., and the linear expansion coefficient of the AZ91 is 27×E⁻⁶/° C.

The linear expansion coefficient of the silicone resin constituting the adhesive 71 in the embodiment is 300×E⁻⁶/° C.

The linear expansion coefficient of the silicone resin constituting such an adhesive 71 is sufficiently higher than those of the quartz glass constituting the liquid crystal panel 61 and the metal member constituting the panel holding member 62. Therefore, the adhesive 71 alone containing no filler may thermally expand to apply a stress to the liquid crystal panel 61, thereby affecting a gap of the liquid crystal layer 610 sandwiched between the pair of substrates. When the gap of the liquid crystal layer 610 varies in this manner, quality of an image formed by the liquid crystal panel 61 may be affected.

On the other hand, when the linear expansion coefficient of the first bonding layer 70 is lower than the linear expansion coefficient of the panel holding member 62, the adhesive 71 cannot follow a stretch caused by the expansion of the panel holding member 62, and the adhesive 71 may be broken.

Through extensive research, the inventor finds that, by adjusting an addition amount of fillers to the adhesive, which have a fibrous shape or a long axis shape having a longitudinal axis, it is possible to form a bonding layer that prevents breakage due to thermal expansion while reducing a stress caused by the thermal expansion on the liquid crystal panel 61. Further, the first bonding layer 70 according to the embodiment is completed.

Here, the linear expansion coefficient of the first bonding layer 70 according to the embodiment is αa, and the linear expansion coefficient of the panel holding member 62 is αc. The linear expansion coefficient αa of the first bonding layer 70 according to the embodiment satisfies αa≥αc. That is, the linear expansion coefficient αa of the first bonding layer 70 is larger than the linear expansion coefficient αc of the panel holding member 62. According to the configuration, the first bonding layer 70 stretches more than the panel holding member 62, and therefore the first bonding layer 70 follows the stretch of the panel holding member 62, thereby preventing the first bonding layer 70 from breaking or peeling off from an interface.

The present inventor finds that even when the first bonding layer 70 is temporarily expanded, occurrence of a display failure due to a gap variation can be prevented by keeping a thermal expansion amount of the first bonding layer 70 to be equal to or less than three pixels of the liquid crystal panel 61.

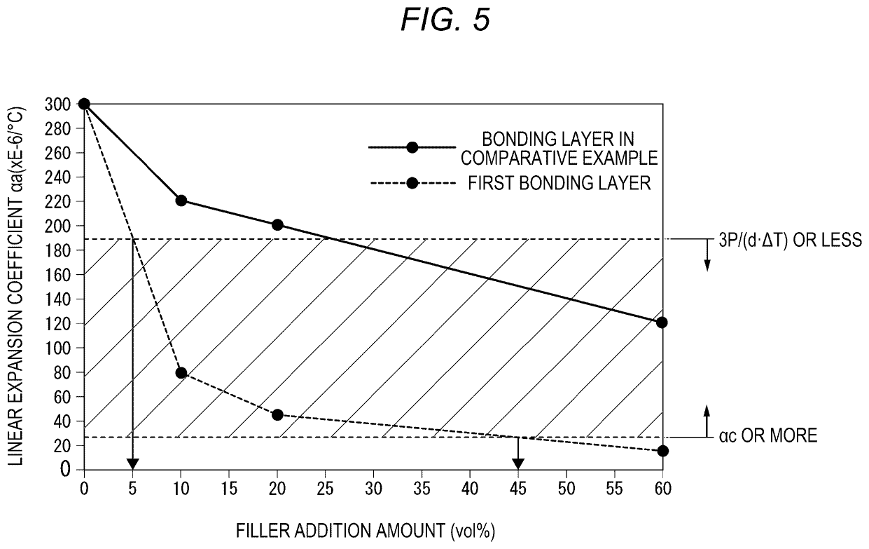

FIG. 5 is a graph showing a relationship between a filler addition amount to the first bonding layer 70 and the linear expansion coefficient thereof. In FIG. 5, a horizontal axis represents the filler addition amount (unit: vol %), and a vertical axis represents the linear expansion coefficient (unit: ×E⁻⁶/° C.). In FIG. 5, a graph showing a relationship between a filler addition amount to a bonding layer obtained by adding a spherical-shaped filler of crystalline silica to a silicone adhesive and a linear expansion coefficient thereof is shown as a comparative example. The first bonding layer 70 shown in FIG. 5 is made of carbon as the first filler 72, and the aluminum alloy ADC12 is used as the material of the panel holding member 62.

In FIG. 5, an optimum range of the linear expansion coefficient αa in the first bonding layer 70 is indicated by hatching. As shown in FIG. 5, the filler addition amount in the first bonding layer 70 is set to 5 vol % to 45 vol %. This is because when the filler addition amount is less than 5 volt, the thermal conductivity of the first bonding layer 70 decreases, and when the filler addition amount is more than 45 vol %, an adhesive content of the bonding layer decreases, resulting in insufficient bonding strength. A more optimum filler addition amount to the first bonding layer 70 is preferably set to 7 vol % to 40 vol %. A further more optimum filler addition amount to the first bonding layer 70 is preferably set to 10 vol % to 30 vol %.

A lower limit of the linear expansion coefficient αa of the first bonding layer 70 shown in FIG. 5 is set based on the linear expansion coefficient αc of the panel holding member 62 (ADC12). That is, the lower limit of the linear expansion coefficient αa of the first bonding layer 70 is set to 21×E⁻⁶/° C. or more, which is the linear expansion coefficient αc of the material (ADC12) of the panel holding member 62.

As the material of the panel holding member 62, the magnesium alloy AZ91 may be used as described above. When the AZ91 is used as the material of the panel holding member 62, the lower limit of the linear expansion coefficient αa of the first bonding layer 70 is set to 27×E⁻⁶/° C. or more, which is the linear expansion coefficient of AZ91.

On the other hand, an upper limit of the linear expansion coefficient αa of the first bonding layer 70 shown in FIG. 5 is set based on a thermal expansion amount of the first bonding layer 70 in which a thermal expansion length of the first bonding layer 70 is three pixels or less. The thermal expansion amount of the first bonding layer 70 is calculated based on a linear expansion coefficient, a maximum thickness, and a change amount in an environmental temperature. The maximum thickness of the first bonding layer 70 shown in FIG. 3 is d, the change amount in the environmental temperature of the first bonding layer 70 is ΔT, and the thermal expansion amount of the first bonding layer 70 is Δd. At this time, the thermal expansion amount Δd of the first bonding layer 70 is calculated by Δd=αa× d×ΔT.

Therefore, when a pixel pitch of the liquid crystal panel 61 is P, the linear expansion coefficient αa of the first bonding layer 70 in which the thermal expansion amount of the first bonding layer 70 is three pixels or less satisfies αa≤3P/(d·ΔT). That is, the upper limit of the linear expansion coefficient αa of the first bonding layer 70 is defined by αa≤3P/(d·ΔT).

The pixel pitch P of the liquid crystal panel 61 changes according to a size of the liquid crystal panel 61. For example, the graph shown in FIG. 5 is a graph in which the pixel pitch P of the liquid crystal panel 61 is 7.5 μm (0.67-inch WUXGA panel) and the maximum thickness d of the first bonding layer 70 is 0.4 mm. The reason for setting the maximum thickness d to 0.4 mm is to reduce the influence of an optical axis deflection of the liquid crystal panel 61 fixed to the panel holding member 62.

The change amount ΔT in the environmental temperature varies depending on cooling conditions of the liquid crystal panel, such as an air cooling method and a liquid cooling method, and is generally in a range of 30° C. to 40° C.

For example, when the change amount ΔT in the environmental temperature is 40° C., the linear expansion coefficient αa of the first bonding layer 70 is 140.6×E⁻⁶/° C. or less. When the change amount ΔT in the environmental temperature is 30° C., the linear expansion coefficient αa of the first bonding layer 70 is 187.5×E⁻⁶/° C. or less.

That is, when the liquid crystal panel 61 having the pixel pitch P of 7.5 μm is bonded, the linear expansion coefficient αa of the first bonding layer 70 is preferably 187.5×E⁻⁶/° C. or less. According to the configuration, since the thermal expansion amount of the first bonding layer 70 is reduced to three pixels or less of the liquid crystal panel 61 having a pixel pitch of 7.5 μm, it is possible to prevent the occurrence of a display failure due to a gap variation of the liquid crystal panel 61 caused by the thermal expansion of the first bonding layer 70.

The pixel pitch P of the liquid crystal panel 61 is not limited to 7.5 μm or less. For example, a case in which the pixel pitch P is 11.6 μm (1.0-inch WUXGA panel) and the maximum thickness d of the first bonding layer 70 is 0.4 mm is considered.

When the change amount ΔT in the environmental temperature is 40° C. and the pixel pitch P of the liquid crystal panel 61 is 11.6 μm, the linear expansion coefficient αa of the first bonding layer 70 is 217.5×E⁻⁶/° C. or less. When the change amount ΔT in the environmental temperature is 30° C. and the pixel pitch P of the liquid crystal panel 61 is 11.6 μm, the linear expansion coefficient αa of the first bonding layer 70 is 290.0×E⁻⁶/° C. or less.

That is, when the liquid crystal panel 61 having the pixel pitch P of 11.6 μm is bonded, the linear expansion coefficient αa of the first bonding layer 70 is preferably 290.0×E⁻⁶/° C. or less. According to the configuration, since the thermal expansion amount of the first bonding layer 70 is reduced to three pixels or less of the liquid crystal panel 61 having the pixel pitch of 11.6 μm, it is possible to prevent the occurrence of a display failure due to a gap variation of the liquid crystal panel 61 caused by the thermal expansion of the first bonding layer 70.

In the bonding layer in the comparative example using the spherical-shaped filler, it is desirable to increase the filler addition amount as much as possible in order to form a favorable heat path, that is, to improve the thermal conductivity. As shown in FIG. 5, the bonding layer in the comparative example has a smaller inclination in the graph than the first bonding layer 70 according to the embodiment. Therefore, in the bonding layer in the comparative example, it is necessary to increase the filler addition amount in order to keep the linear expansion coefficient to be low while improving the thermal conductivity. For example, in the bonding layer in the comparative example, when the linear expansion coefficient is 120×E⁻⁶/° C., the filler addition amount is required to be 60 vol %. However, when the filler addition amount is 60 vol %, the bonding strength of the bonding layer is insufficient as described above.

Therefore, in the bonding layer in the comparative example, it is difficult to implement configuration excellent in bonding reliability and thermal conductivity.

On the other hand, according to the first bonding layer 70 in the embodiment, the linear expansion coefficient can be adjusted to a low value with a smaller filler addition amount compared to when the spherical-shaped filler is used, thereby preventing a decrease in bonding reliability that accompanies an increase in the filler addition amount. In the first bonding layer 70 in the embodiment, a balance between the thermal conductivity and the bonding strength is excellent by setting the filler addition amount to 5 vol % to 45 vol %.

According to the first bonding layer 70 in the embodiment, the heat path HC is formed in the first bonding layer 70 by the first filler 72 having a fibrous shape or a long axis shape having a longitudinal axis, so that the thermal conductivity can be improved. That is, according to the first bonding layer 70 in the embodiment, a configuration excellent in the bonding reliability and the thermal conductivity can be implemented.

### Effects of First Embodiment

The liquid crystal device 6 according to the embodiment includes the liquid crystal panel 61 including a pair of substrates 611 and 612 holding the liquid crystal layer 610, the panel holding member 62 holding the liquid crystal panel 61, and the first bonding layer 70 bonding the liquid crystal panel 61 to the panel holding member 62. The first bonding layer 70 contains the adhesive 71 and the plurality of first fillers 72 added to the adhesive 71, which have a fibrous shape or a long axis shape having a longitudinal axis. The thermal conductivity of the first fillers 72 is higher than the thermal conductivity of the adhesive 71.

In the liquid crystal device 6 according to the embodiment, the first bonding layer 70 contains the adhesive 71 and the plurality of first fillers 72 added to the adhesive 71, which have a long axis shape or a fibrous shape, the thermal conductivity of the first fillers 72 is higher than the thermal conductivity of the adhesive 71, and the plurality of first fillers 72 form the heat path HC that transfers heat from the liquid crystal panel 61 to the panel holding member 62.

According to the liquid crystal device 6 in the embodiment, the heat path HC extending from the liquid crystal panel 61 to the panel holding member 62 by the plurality of first fillers 72 can be formed in the first bonding layer 70.

Here, when the heat path is formed in the bonding layer by increasing a filling rate of the spherical-shaped filler as in the related art, an amount of the adhesive decreases, which may reduce an adhesive strength of the bonding layer, which may result in peeling off or damage to the liquid crystal panel 61.

In contrast, the first bonding layer 70 according to the embodiment efficiently forms the heat path HC by aligning the longitudinal axis Lx of the first filler 72 along the thickness direction, so that a sufficient bonding strength can be obtained without reducing the amount of the adhesive 71.

Therefore, according to the liquid crystal device 6 in the embodiment, the liquid crystal panel 61 is stably held and efficiently cooled, so that a deterioration in the liquid crystal panel 61 due to heat can be prevented over a long period of time.

The projector 1 according to the embodiment includes the light source device 2, the light modulation devices 40R, 40G, and 40B that modulate the light emitted from the light source device 2 and include the liquid crystal device 6, and the projection optical device 5 that projects the light modulated by the light modulation devices 40R, 40G, and 40B.

According to the projector 1 in the embodiment, it is possible to provide a projector having excellent display quality and high efficiency.

### Second Embodiment

A liquid crystal device according to a second embodiment will be described below.

The basic configuration of the liquid crystal device according to the second embodiment is the same as that in the first embodiment, but the configuration of the first bonding layer differs from that in the first embodiment. Therefore, the configuration of the first bonding layer will be mainly described below.

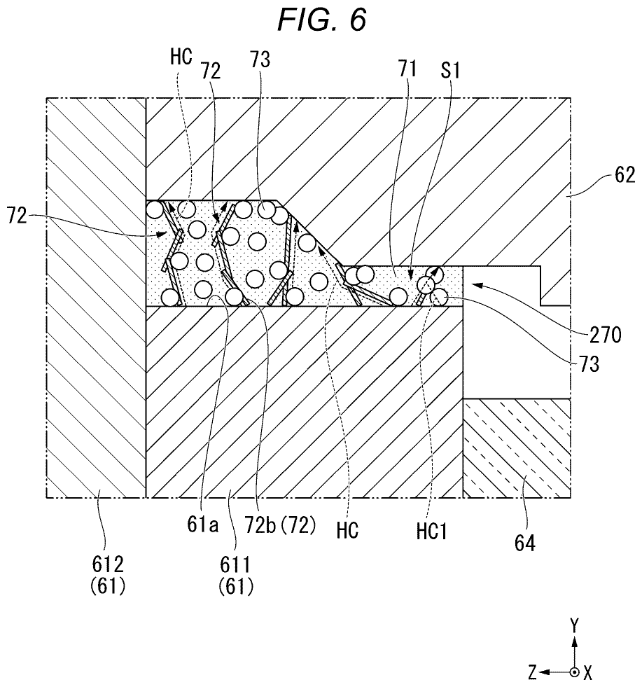

FIG. 6 is an enlarged cross-sectional view showing a configuration of main parts of a first bonding layer 270 according to the embodiment. In FIG. 6 components common to those in the drawings used in the above embodiment are denoted by the same reference numerals, and a description thereof is omitted.

As shown in FIG. 6, the first bonding layer 270 according to the embodiment includes the adhesive 71, the plurality of first fillers 72, and a plurality of second fillers 73.

The plurality of second fillers 73 each have a spherical shape. Each of the second fillers 73 is made of crystalline silica.

According to the first bonding layer 270 in the embodiment, the first fillers 72 and the second fillers 73 are in contact with each other, which makes it easier to form a heat path in the thickness direction.

As shown in FIG. 6, a narrow gap S1 that is smaller than other gaps is formed between the outer peripheral edge 61a of the liquid crystal panel 61 and the inner surface 62a of the panel holding member 62, and it is difficult for the first fillers 72 to uniformly enter the narrow gap S1.

According to the first bonding layer 270 in the embodiment, the spherical-shaped second fillers 73 can be favorably inserted into the narrow gap S1. When the narrow gap S1 is a small gap, the spherical-shaped second fillers 73 come into contact with each other, and thus a heat path HCl can be formed in the thickness direction. Therefore, according to the first bonding layer 270 in the embodiment, even when the narrow gap S1 is formed between the outer peripheral edge 61a of the liquid crystal panel 61 and the inner surface 62a of the panel holding member 62, the heat path can be favorably formed between the liquid crystal panel 61 and the panel holding member 62. Therefore, according to the liquid crystal device in the embodiment, the liquid crystal panel 61 is held by the panel holding member 62 via the first bonding layer 270, and therefore, by stably holding and efficiently cooling the liquid crystal panel 61, a deterioration in the liquid crystal panel 61 due to the heat can be prevented over a long period of time.

### Third Embodiment

A liquid crystal device according to a third embodiment will be described below.

The basic configuration of the liquid crystal device according to the third embodiment is the same as that in the first embodiment, but the configuration of the first bonding layer differs from that in the first embodiment. Therefore, the configuration of the first bonding layer will be mainly described below.

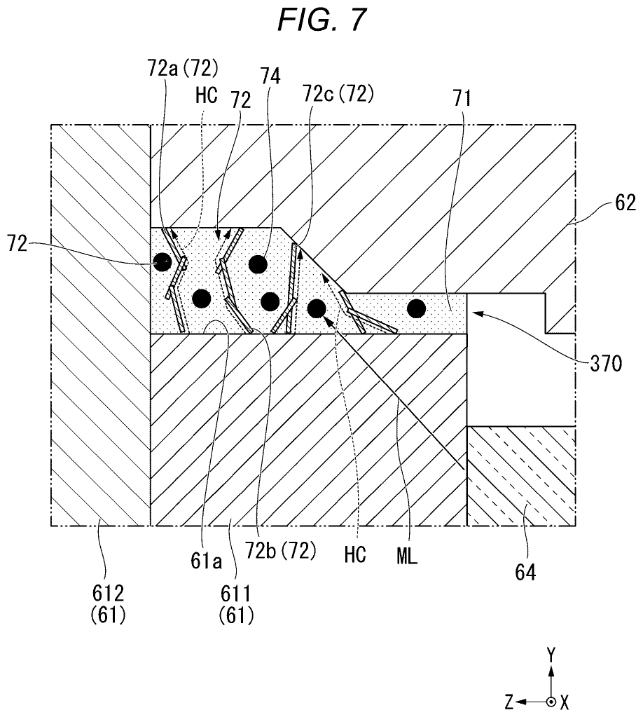

FIG. 7 is an enlarged cross-sectional view showing a configuration of main parts of a first bonding layer 370 according to the embodiment. In FIG. 7, components common to those in the drawings used in the above embodiment are denoted by the same reference numerals, and a description thereof is omitted.

Here, a part of the light incident on a liquid crystal panel may be incident on a bonding layer as stray light. In general, since an adhesive contained in a bonding layer is white, there is a chance that the stray light is reflected between the substrate of the liquid crystal panel 61 and the panel holding member 62 via the adhesive and is incident on the liquid crystal panel 61 again to cause a defect in a display image such as color unevenness.

In contrast, as shown in FIG. 7, the first bonding layer 370 according to the embodiment contains the adhesive 71, the plurality of first fillers 72, and a plurality of third fillers 74.

Each of the third fillers 74 is made of a material having a reflectance of 30% or less. In the embodiment, for example, carbon or carbon nanotubes can be used as the material of the third filler 74. Carbon and carbon nanotubes have extremely high thermal conductivity, are black in color, and absorb light, resulting in a low reflectance of 5% or less. A shape of the third fillers 74 is not particularly limited, and may be a long axis shape similar to that of the first filler 72, or a spherical shape similar to that of the second filler 73.

According to the first bonding layer 370 in the embodiment, by including the third filler 74 having a reflectance of 30% or less in the adhesive 71, it is possible to absorb, by the third fillers 74, a part of stray light ML incident on the adhesive 71 from the liquid crystal panel 61. Accordingly, it is possible to reduce a light amount of the stray light reflected between the substrate of the liquid crystal panel 61 and the panel holding member 62 via the adhesive 71 and incident on the liquid crystal panel 61 again. Therefore, it is possible to prevent an occurrence of a display failure of the liquid crystal panel 61 due to the stray light.

### Fourth Embodiment

A liquid crystal device according to a fourth embodiment will be described below.

The basic configuration of the liquid crystal device according to the fourth embodiment is the same as that of the first embodiment, and is different from that of the first embodiment in that the liquid crystal device according to the fourth embodiment further includes a vapor chamber and a Peltier element that enhance cooling performance of the liquid crystal panel.

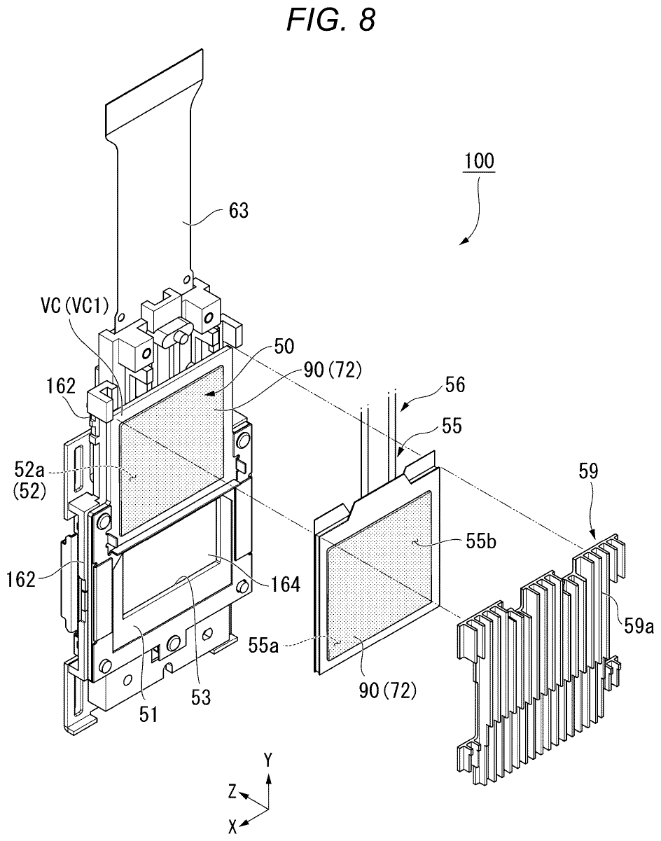

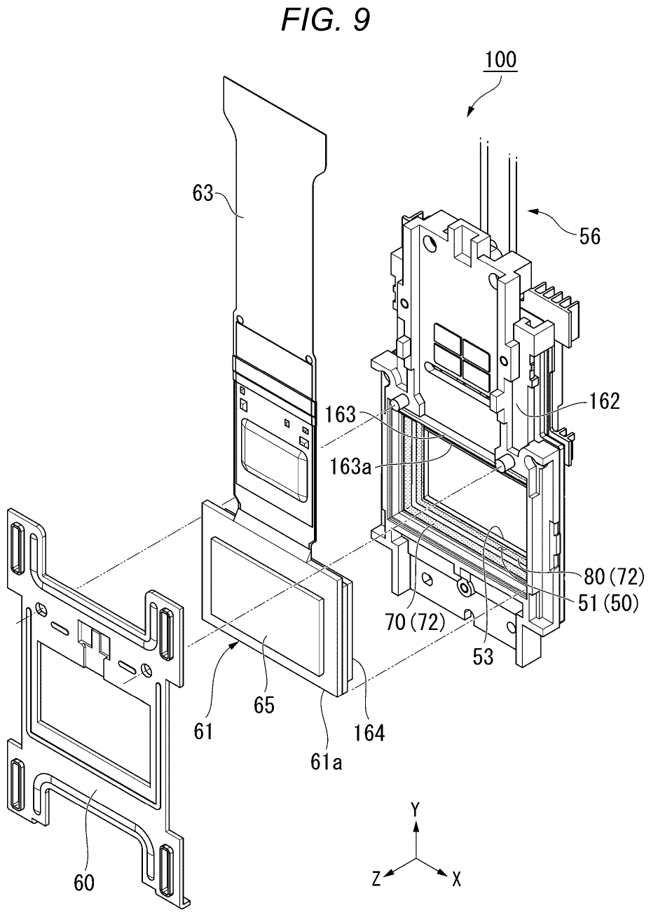

FIG. 8 is an exploded perspective view showing a schematic configuration of the liquid crystal device according to the embodiment as viewed from the light incident side. FIG. 9 is an exploded perspective view showing a schematic configuration of the liquid crystal device according to the embodiment as viewed from the light emission side. In FIG. 9, components common to those in the drawings used in the first embodiment will be denoted by the same reference numerals, and a description thereof is omitted.

As shown in FIGS. 8 and 9, the liquid crystal device 100 according to the embodiment includes the liquid crystal panel 61, a panel holding member 162, the FPC 63, an incident side dustproof substrate 164 and an emission side dustproof substrate 65 which sandwich the liquid crystal panel 61 in a direction along the Z axis, a heat diffusion member 50, a thermoelectric conversion device 55, a heat dissipation member 59, the first bonding layer 70, a second bonding layer 80, a third bonding layer 90, and the back side plate 60.

The heat diffusion member 50 includes a heat receiving portion 51 that receives heat from the liquid crystal panel 61, a heat dissipating portion 52 that dissipates the heat received by the heat receiving portion 51, and an opening 53. The heat diffusion member 50 is attached to the panel holding member 162.

The heat diffusion member 50 is a vapor chamber VC having a sealed housing VC1 in which a working fluid capable of changing between a gas phase and a liquid phase is sealed.

The heat receiving portion 51 is provided on a surface of the heat diffusion member 50 on the light emission side, and the heat dissipating portion 52 is provided on a surface of the heat diffusion member 50 on the light incident side.

When the heat diffusion member 50 is attached to the panel holding member 162, the opening 53 allows light incident on the liquid crystal panel 61 to pass therethrough in the +Z direction. That is, the opening 53 is a through hole penetrating the heat diffusion member 50 along the +Z direction. The opening 53 is formed in a substantially rectangular shape corresponding to the pixel region of the liquid crystal panel 61 when viewed from the light incident side. The heat receiving portion 51 comes into contact with the incident side dustproof substrate 164 and receives heat from the liquid crystal panel 61 via the incident side dustproof substrate 164. The incident side dustproof substrate 164 according to the embodiment is made of a sapphire substrate having excellent thermal conductivity. Therefore, the heat from the liquid crystal panel 61 is transferred to the heat receiving portion 51 of the heat diffusion member 50 via the incident side dustproof substrate 164.

In the case of the embodiment, since the incident side dustproof substrate 164 is formed of the sapphire substrate having excellent thermal conductivity, the heat receiving portion 51 of the heat diffusion member 50 is thermally connected to the liquid crystal panel 61 via the incident side dustproof substrate 164. According to the configuration, the heat from the liquid crystal panel 61 is efficiently transferred to the heat receiving portion 51 of the heat diffusion member 50 via the incident side dustproof substrate 164, and thus heat dissipation of the liquid crystal panel 61 can be efficiently enhanced. When the incident side dustproof substrate 164 is formed of the sapphire substrate, the heat receiving portion 51 of the heat diffusion member 50 is preferably not in contact with the panel holding member 62. If the heat receiving portion 51 of the heat diffusion member 50 comes into contact with the panel holding member 62, the heat from the liquid crystal panel 61 is less efficiently transferred to the incident side dustproof substrate 164, resulting in a decrease in heat dissipation efficiency of the liquid crystal panel 61.

On the other hand, since the sapphire substrate is very expensive, for example, it is also conceivable to use quartz glass as the material for the incident side dustproof substrate 164 due to a cost restriction. In such a case, the heat receiving portion 51 of the heat diffusion member 50 is preferably in contact with the panel holding member 62. According to the configuration, although the thermal conductivity of the incident side dustproof substrate 164 is reduced as compared with the case in which the sapphire substrate is used, the heat from the liquid crystal panel 61 can be transferred from both the incident side dustproof substrate 164 and the panel holding member 62 to the heat receiving portion 51 of the heat diffusion member 50, and as a result, the heat dissipation of the liquid crystal panel 61 can be enhanced.

Among the working fluid in a liquid phase sealed in the sealed housing VC1, a part of the working fluid is vaporized by the heat from the liquid crystal panel 61 received by the heat receiving portion 51 to change into the working fluid in a gas phase, and diffuses in the sealed housing VC1. A part of the working fluid in the gas phase transfers the heat to the heat dissipating portion 52 which is a portion of the sealed housing VC1 having a low temperature. Accordingly, the working fluid in the gas phase is condensed by dissipating heat in the heat dissipating portion 52 and is changed into the working fluid in the liquid phase. The working fluid changed to the liquid phase is transferred along an inner surface of the sealed housing VC1 and is moved to the heat receiving portion 51 again.

The heat diffusion member 50 is provided with the thermoelectric conversion device 55 at a portion corresponding to the heat dissipating portion 52. The thermoelectric conversion device 55 has a first surface 55a, a second surface 55b, and a lead wire 56. The first surface 55a is a surface of the thermoelectric conversion device 55 that faces the heat dissipating portion 52 of the heat diffusion member 50. The second surface 55b is a surface of the thermoelectric conversion device 55 facing in the −Z direction on an opposite side from the first surface 55a, and is in contact with the heat dissipation member 59. The heat dissipation member 59 is configured with a heat sink containing a plurality of fins 59a.

The lead wire 56 extends in the +Y direction from an end portion of the thermoelectric conversion device 55 in the +Y direction. The thermoelectric conversion device 55 actively absorbs the heat transferred from the heat dissipating portion 52 at the first surface 55a by power supplied from the lead wire 56, and dissipates the absorbed heat to the heat dissipation member 59 from the second surface 55b.

The thermoelectric conversion device 55 according to the embodiment is a Peltier element. Therefore, by reversing a polarity of the thermoelectric conversion device 55, the heat can be supplied from the first surface 55a to the heat dissipating portion 52. That is, the thermoelectric conversion device 55 can heat the liquid crystal panel 61 via the heat diffusion member 50. At this time, in the heat diffusion member 50, the working fluid in the liquid phase near the heat dissipating portion 52 is changed to the working fluid in the gas phase by the heat supplied from the thermoelectric conversion device 55, and the working fluid in the gas phase diffuses in the sealed housing VC1. Further, a part of the working fluid among working fluids in the gas phase transfers the heat to the heat receiving portion 51, and the heat is supplied from the heat receiving portion 51 to the liquid crystal panel 61. When the heat is supplied from the first surface 55a to the heat diffusion member 50, the second surface 55b serves as a heat absorbing surface and absorbs the heat from the heat dissipation member 59.

As shown in FIG. 9, the first bonding layer 70 bonds the outer peripheral edge 61a of the liquid crystal panel 61 and an inner surface 163a of a frame body 163 of the panel holding member 162.

As shown in FIG. 8, the second bonding layer 80 bonds the liquid crystal panel 61 and the heat receiving portion 51 provided around the opening 53 of the heat diffusion member 50. Similarly to the first bonding layer 70, the second bonding layer 80 contains the plurality of first fillers 72. According to the configuration, the second bonding layer 80 can efficiently transfer the heat from the liquid crystal panel 61 to the heat receiving portion 51 by forming, by the plurality of first fillers 72, heat paths from the liquid crystal panel 61 to the heat receiving portion 51 of the heat diffusion member 50. When the polarity of the thermoelectric conversion device 55 is reversed, the second bonding layer 80 can form the heat path from the heat receiving portion 51 of the heat diffusion member 50 to the liquid crystal panel 61.

The third bonding layer 90 bonds the heat diffusion member 50 and the heat dissipation member 59. In the embodiment, the third bonding layer 90 bonds the heat diffusion member 50 and the heat dissipation member 59 in a state in which the thermoelectric conversion device 55 is sandwiched between the heat diffusion member 50 and the heat dissipation member 59. Specifically, the third bonding layer 90 bonds the heat dissipating portion 52 of the heat diffusion member 50 and the first surface 55a of the thermoelectric conversion device 55, and bonds the second surface 55b of the thermoelectric conversion device 55 and the heat dissipation member 59. Similarly to the first bonding layer 70, the third bonding layer 90 contains the plurality of first fillers 72.

According to the configuration, the third bonding layer 90 can efficiently transfer the heat from the heat diffusion member 50 to the thermoelectric conversion device 55 by forming, by the plurality of first fillers 72, the heat paths from the heat dissipating portion 52 of the heat diffusion member 50 to the thermoelectric conversion device 55. When the polarity of the thermoelectric conversion device 55 is reversed, the third bonding layer 90 can form the heat path from the thermoelectric conversion device 55 to the heat dissipating portion 52 of the heat diffusion member 50.

The third bonding layer 90 can efficiently transfer the heat from the thermoelectric conversion device 55 to the heat dissipation member 59 by forming, by the plurality of first fillers 72, the heat paths from the thermoelectric conversion device 55 to the heat dissipation member 59. When the polarity of the thermoelectric conversion device 55 is reversed, the third bonding layer 90 can form the heat path from the heat dissipation member 59 to the thermoelectric conversion device 55.

As described above, according to the liquid crystal device 100 in the embodiment, the heat from the liquid crystal panel 61 can be rapidly dissipated by adopting the vapor chamber VC as the heat diffusion member 50. Accordingly, cooling efficiency of the liquid crystal panel 61 can be enhanced.

Since the thermoelectric conversion device 55 is a Peltier element, the heat can be actively absorbed from the heat dissipating portion 52 of the heat diffusion member 50, and the heat from the liquid crystal panel 61 can be efficiently dissipated to the heat dissipation member 59. Accordingly, the cooling efficiency of the liquid crystal panel 61 can be enhanced.

Here, when the temperature of the liquid crystal panel 61 is low, there is a chance that responsiveness of the liquid crystal decreases and the formed image deteriorates. In particular, when an image having a high frame rate is formed, the image formation cannot follow the frame rate, and an image corresponding to an image signal input to the liquid crystal panel 61 may not be formed.

Even in such a case, according to the liquid crystal device 100 in the embodiment, the temperature of the liquid crystal layer can be increased by heating the liquid crystal panel 61 via the heat diffusion member 50 by the thermoelectric conversion device 55 which is a Peltier element. Therefore, it is possible to prevent a decrease in responsiveness of the liquid crystal in the liquid crystal panel 61.

On the other hand, when the temperature of the liquid crystal panel 61 is high, the liquid crystal is likely to deteriorate, and a life of the liquid crystal panel 61 is likely to be shortened. In contrast, since the thermoelectric conversion device 55 actively absorbs the heat from the liquid crystal panel 61 via the heat diffusion member 50, the heat from the liquid crystal panel 61 can be easily dissipated to the heat dissipation member 59.

The technical scope of the present disclosure is not limited to the embodiments described above, and a variety of changes can be made thereto without departing from the intent of the present disclosure.

In addition to the above, the specific descriptions of the shapes, the numbers, the arrangements, the materials, and other factors of the elements of the liquid crystal device and the projector are not limited to those in the above-described embodiments and can be changed as appropriate. In the above embodiments, an example in which the projector according to the present disclosure is applied to a projector that performs light modulation using a liquid crystal device is shown, and the present disclosure is not limited thereto.

The projector according to the present disclosure may be applied to a projector that performs light modulation using a light modulation device including a digital micromirror device as a light modulation element. In this case, the light modulation device according to the present disclosure may adopt a configuration in which the digital micromirror device and a holding member for holding the digital micromirror device are bonded using the first bonding layer 70. That is, the light modulation device according to the present disclosure includes: a light modulation element configured to modulate incident light as image light; a holding member configured to hold the light modulation element; and a bonding layer bonding the light modulation element to the holding member. The bonding layer contains an adhesive and a filler added to the adhesive, the filler having a fibrous shape or a long axis shape having a longitudinal axis, and thermal conductivity of the filler is higher than thermal conductivity of the adhesive.

According to the light modulation device having the above configuration, by stably holding and efficiently cooling the digital micromirror device, it is possible to prevent a deterioration in the digital micromirror device due to heat for a long period of time. In addition, in a projector including a light modulation device, it is also possible to provide a projector having excellent display quality and high efficiency.

The projector according to the present disclosure is not required to include the plurality of light modulation devices (liquid crystal devices) and may include only one light modulation device (liquid crystal device).

The present disclosure will be summarized below as appendices.

### Appendix 1

A liquid crystal device includes:
a liquid crystal panel including a pair of substrates which hold a liquid crystal layer;
a panel holding member configured to hold the liquid crystal panel; and
a first bonding layer configured to bond the liquid crystal panel to the panel holding member,
the first bonding layer contains an adhesive and a plurality of first fillers added to the adhesive, the first fillers having a fibrous shape or a long axis shape having a longitudinal axis, and
thermal conductivity of the first fillers is higher than thermal conductivity of the adhesive.

According to the liquid crystal device in the appendix 1, heat paths extending from the liquid crystal panel to the panel holding member by the plurality of first fillers can be formed in the first bonding layer. When the heat paths are formed in the bonding layer by increasing a filling rate of a spherical-shaped filler as in the related art, an amount of the adhesive decreases, which may reduce an adhesive strength provided by the bonding layer, which may result in peeling off or damage to the liquid crystal panel.

In contrast, in the configuration according to the appendix 1, since the first filler efficiently forms the heat path, it is possible to obtain a sufficient bonding strength without reducing the amount of the adhesive.

Therefore, according to the configuration, it is possible to provide a liquid crystal device in which the liquid crystal panel is stably held and efficiently cooled, so that a deterioration in the liquid crystal panel due to heat is prevented over a long period of time.

### Appendix 2

In the liquid crystal device according to the appendix 1,
the first bonding layer further contains a second filler having a granular shape.

According to the appendix 2, the first fillers and the second fillers are in contact with each other, which makes it easier to form a heat path in a thickness direction. In addition, since the spherical-shaped second fillers favorably enter a narrow gap having a smaller gap than other narrow gaps in a region where the first bonding layer is disposed, the second fillers come into contact with each other, so that the heat path can be favorably formed in the thickness direction of the narrow gap.

### Appendix 3

In the liquid crystal device according to the appendices 1 and 2,
αa≥αc, where αa is a linear expansion coefficient of the first bonding layer and αc is a linear expansion coefficient of the panel holding member.

According to the configuration of the appendix 3, the linear expansion coefficient of the first bonding layer can be made larger than the linear expansion coefficient of the panel holding member. Accordingly, the first bonding layer stretches more than the panel holding member, and therefore the first bonding layer follows the stretch of the panel holding member, thereby preventing the first bonding layer from breaking or peeling off from an interface.

### Appendix 4

In the liquid crystal device according to the appendix 3,
the panel holding member is formed of an aluminum alloy ADC12, and
the linear expansion coefficient αa of the first bonding layer is 21×E⁻⁶/° C. or more.

According to the configuration of the appendix 4, the linear expansion coefficient of the first bonding layer can be made larger than the linear expansion coefficient of the panel holding formed by the aluminum alloy ADC12. Accordingly, the first bonding layer stretches more than the panel holding member, and therefore the first bonding layer follows the stretch of the panel holding member, thereby preventing the first bonding layer from breaking or peeling off from an interface.

### Appendix 5

In the liquid crystal device according to the appendix 3,
the panel holding member is formed of a magnesium alloy AZ91, and
the linear expansion coefficient αa of the first bonding layer is 27×E⁻⁶/° C. or more.

According to the configuration of the appendix 5, the linear expansion coefficient of the first bonding layer can be made larger than the linear expansion coefficient of the panel holding member formed by the magnesium alloy AZ91. Accordingly, the first bonding layer stretches more than the panel holding member, and therefore the first bonding layer follows the stretch of the panel holding member, thereby preventing the first bonding layer from breaking or peeling off from an interface.

### Appendix 6

In the liquid crystal device according to any one of the appendices 1 to 5,
αa≤3P/(d·ΔT), where P is a pixel pitch of the liquid crystal panel, d is a maximum thickness of the first bonding layer, and ΔT is a change amount in an environmental temperature of the liquid crystal panel.

According to the configuration of the appendix 6, since the thermal expansion amount of the first bonding layer is reduced to three pixels or less of the liquid crystal panel, it is possible to prevent the occurrence of a display failure due to a gap variation of the liquid crystal panel.

### Appendix 7

In the liquid crystal device according to the appendix 6,
the maximum thickness d of the first bonding layer is 0.4 mm, and
the change amount ΔT in the environmental temperature is 30° C. to 40° C.

According to the configuration of the appendix 7,

### Appendix 8

In the liquid crystal device according to the appendix 7,
the pixel pitch P of the liquid crystal panel is 11.6 μm or less, and
the linear expansion coefficient αa of the first bonding layer is 290.0×E⁻⁶/° C. or less.

According to the configuration of the appendix 8, in the liquid crystal panel having the pixel pitch of 11.6 μm, it is possible to prevent the occurrence of a display failure due to a gap variation caused by the thermal expansion of the first bonding layer.

### Appendix 9

In the liquid crystal device according to the appendix 8,
the pixel pitch P of the liquid crystal panel is 7.5 μm or less, and
the linear expansion coefficient αa of the first bonding layer is 187.5×E⁻⁶/° C. or less.

According to the configuration of the appendix 9, in the liquid crystal panel having the pixel pitch of 7.5 μm, it is possible to prevent the occurrence of a display failure due to a gap variation caused by the thermal expansion of the first bonding layer.

### Appendix 10

In the liquid crystal device according to any one of the appendices 1 to 9,
a content of the plurality of first fillers in the first bonding layer is 5 vol % to 45 vol %.

According to the configuration of the appendix 10, it is possible to provide a bonding layer excellent in a balance between thermal conductivity and a bonding strength.

### Appendix 11

In the liquid crystal device according to any one of the appendices 1 to 10,
the first bonding layer further contains a third filler having a reflectance of 30% or less.

According to the configuration of the appendix 11, by including the third fillers having the reflectance of 30% or less in the adhesive, it is possible to absorb, by the third fillers, a part of stray light incident on the adhesive from the liquid crystal panel. Accordingly, it is possible to reduce a light amount of the stray light reflected between the liquid crystal panel and the panel holding member via the adhesive and incident on the liquid crystal panel again. Therefore, it is possible to prevent an occurrence of a display failure of the liquid crystal panel due to the stray light.

### Appendix 12

The liquid crystal device according to any one of the appendices 1 to 11, further includes:
a heat diffusion member which is bonded to the liquid crystal panel via a second bonding layer, and which includes a heat receiving portion configured to receive heat from the liquid crystal panel and a heat dissipating portion configured to dissipate the heat received by the heat receiving portion; and
a heat dissipation member bonded to the heat dissipating portion of the heat diffusion member via a third bonding layer, and configured to dissipate the heat from the heat diffusion member.

According to the configuration of the appendix 12, the heat transferred from the liquid crystal panel to the heat diffusion member can be efficiently dissipated via the heat dissipation member. Therefore, the liquid crystal panel can be efficiently cooled.

### Appendix 13

In the liquid crystal device according to the appendix 12,
the heat diffusion member is also in contact with the panel holding member.

According to the configuration of the appendix 13, the heat from the panel holding member can be efficiently dissipated by the heat diffusion member.

### Appendix 14

The liquid crystal device according to the appendix 12 or 13, further includes:
a thermoelectric conversion device disposed between the heat dissipating portion of the heat diffusion member and the heat dissipation member,
the thermoelectric conversion device is bonded to the heat diffusion member and the heat dissipation member via the third bonding layer.

According to the configuration of the appendix 14, the heat from the heat diffusion member can be efficiently dissipated to the heat dissipation member by the thermoelectric conversion device.

### Appendix 15

In the liquid crystal device according to the appendix 14,
the second bonding layer and the third bonding layer each contain the plurality of first fillers.

According to the configuration of the appendix 15, a heat path can be efficiently formed in the second bonding layer and the third bonding layer by the first fillers.

### Appendix 16

A projector includes:
a light source device;
the liquid crystal device according to any one of the appendices 1 to 15, which is configured to modulate light emitted from the light source device; and
a projection optical device configured to project the light modulated by the liquid crystal device.

The projector having the configuration

according to the appendix 16 can provide a projector having excellent display quality and high efficiency.

### Appendix 17

A light modulation device includes:
a light modulation element configured to modulate incident light as image light;
a holding member configured to hold the light modulation element; and
a bonding layer bonding the light modulation element to the holding member, wherein
the bonding layer contains an adhesive and a filler added to the adhesive, the filler having a fibrous shape or a long axis shape having a longitudinal axis, and
thermal conductivity of the filler is higher than thermal conductivity of the adhesive.

According to the configuration of the appendix 17, since the first filler efficiently forms the heat path, it is possible to obtain a sufficient bonding strength without reducing the amount of the adhesive.

Therefore, according to the configuration, it is possible to provide a light modulation device in which the light modulation element is stably held and efficiently cooled, so that a deterioration in the light modulation element due to heat is prevented over a long period of time.

### Appendix 18

A projector includes:
a light source device;
the light modulation device according to the appendix 17, which is configured to modulate light emitted from the light source device; and
a projection optical device configured to project the light modulated by the light modulation device.

The projector having the configuration according to the appendix 18 can provide a projector having excellent display quality and high efficiency.

What is claimed is:

1. A liquid crystal device comprising:
a liquid crystal panel including a pair of substrates which hold a liquid crystal layer;
a panel holding member configured to hold the liquid crystal panel; and
a first bonding layer configured to bond the liquid crystal panel to the panel holding member, wherein
the first bonding layer contains an adhesive and a plurality of first fillers added to the adhesive, the first fillers having a fibrous shape or a long axis shape having a longitudinal axis, and
thermal conductivity of the first fillers is higher than thermal conductivity of the adhesive.

2. The liquid crystal device according to claim 1, wherein
the first bonding layer further contains a second filler having a granular shape.

3. The liquid crystal device according to claim 1, wherein
αa≥αc, where αa is a linear expansion coefficient of the first bonding layer and αc is a linear expansion coefficient of the panel holding member.

4. The liquid crystal device according to claim 3, wherein
the panel holding member is formed of an aluminum alloy ADC12, and
the linear expansion coefficient αa of the first bonding layer is 21×E⁻⁶/° C. or more.

5. The liquid crystal device according to claim 3, wherein
the panel holding member is formed of a magnesium alloy AZ91, and
the linear expansion coefficient αa of the first bonding layer is 27×E⁻⁶/° C. or more.

6. The liquid crystal device according to claim 1, wherein
αa≤3P/(d·ΔT), where P is a pixel pitch of the liquid crystal panel, d is a maximum thickness of the first bonding layer, and ΔT is a change amount in an environmental temperature of the liquid crystal panel.

7. The liquid crystal device according to claim 6, wherein
the maximum thickness d of the first bonding layer is 0.4 mm, and
the change amount ΔT in the environmental temperature is 30° C. to 40° C.

8. The liquid crystal device according to claim 7, wherein
the pixel pitch P of the liquid crystal panel is 11.6 μm or less, and
the linear expansion coefficient αa of the first bonding layer is 290.0×E⁻⁶/° C. or less.

9. The liquid crystal device according to claim 8, wherein
the pixel pitch P of the liquid crystal panel is 7.5 μm or less, and
the linear expansion coefficient αa of the first bonding layer is 187.5×E⁻⁶/° C. or less.

10. The liquid crystal device according to claim 1, wherein
a content of the plurality of first fillers in the first bonding layer is 5 vol % to 45 vol %.

11. The liquid crystal device according to claim 1, wherein
the first bonding layer further contains a third filler having a reflectance of 30% or less.

12. The liquid crystal device according to claim 1, further comprising:
a heat diffusion member which is bonded to the liquid crystal panel via a second bonding layer, and which includes a heat receiving portion configured to receive heat from the liquid crystal panel and a heat dissipating portion configured to dissipate the heat received by the heat receiving portion; and
a heat dissipation member bonded to the heat dissipating portion of the heat diffusion member via a third bonding layer, and configured to dissipate the heat from the heat diffusion member.

13. The liquid crystal device according to claim 12, wherein
the heat diffusion member is also in contact with the panel holding member.

14. The liquid crystal device according to claim 12, further comprising:
a thermoelectric conversion device disposed between the heat dissipating portion of the heat diffusion member and the heat dissipation member, wherein
the thermoelectric conversion device is bonded to the heat diffusion member and the heat dissipation member via the third bonding layer.

15. The liquid crystal device according to claim 14, wherein
the second bonding layer and the third bonding layer each contain the plurality of first fillers.

16. A projector comprising:
a light source device;
the liquid crystal device according to claim 1, which is configured to modulate light emitted from the light source device; and
a projection optical device configured to project the light modulated by the liquid crystal device.

17. A light modulation device comprising:
a light modulation element configured to modulate incident light as image light;
a holding member configured to hold the light modulation element; and
a bonding layer configured to bond the light modulation element to the holding member, wherein
the bonding layer contains an adhesive and a filler added to the adhesive, the filler having a fibrous shape or a long axis shape having a longitudinal axis, and
thermal conductivity of the filler is higher than thermal conductivity of the adhesive.

18. A projector comprising:
a light source device;
the light modulation device according to claim 17, which is configured to modulate light emitted from the light source device; and
a projection optical device configured to project the light modulated by the light modulation device.
